(19) United States
(12) Patent Application Publication
(10) Pub. No.: US 2026/0031730 A1
(43) Pub. Date: Jan. 29, 2026

(54) NON-ISOLATED FULL BRIDGE POWER CONVERTER DRIVE SYSTEM

(71) Applicant: Flex Ltd., Singapore (SG)

(72) Inventor: Feng Shu Hai, Shanghai (CN)

(73) Assignee: Flex Ltd., Singapore (SG)

(21) Appl. No.: 18/805,714

(22) Filed: Aug. 15, 2024

(30) Foreign Application Priority Data
Jul. 26, 2024 (CN) 202411017609.X

(51) Int. Cl. H02M 3/158

(52) U.S. Cl. CPC H02M 3/1588

(57) ABSTRACT

An apparatus includes multiple switching elements operable to convey energy from a voltage source to the primary winding of the transformer. The switching elements include first switching elements connected on a first side of the transformer, including a first upper switching element, a first middle switching element, and a first lower switching element. The switching elements include second switching elements connected on a second side of the transformer opposite the first side of the transformer, the second switching elements including a second upper switching element, a second middle switching element, and a second lower switching element. Control circuitry controls switching of the first switching elements and the second switching elements to regulate an output voltage of the apparatus by operating the first upper switching element and the second upper switching element in a synchronous rectification mode.

### CROSS REFERENCE TO RELATED APPLICATION

The present application claims the benefit of and priority to Chinese Patent Application No. 202411017609.X filed Jul. 26, 2024, the entire disclosure of which is hereby incorporated by reference for all that it teaches and for all purposes FIELD

The present disclosure is generally directed to power converters and more particularly directed to drive logic for a non-isolated pulse width modulated (PWM) full bridge direct current (DC)-to-DC power converter with interconnected transformer windings.

### BACKGROUND

DC-to-DC power converters convert a DC voltage at one level to a DC voltage at another level and deliver power to a load. Such converters typically include a transformer, which provides power transfer from a primary input to a secondary output as a voltage converter. The transformer may also provide galvanic isolation between the primary input and the secondary output in most applications, which is the physical and electrical separation between the primary input and the secondary output. As a result of the isolation, each of the isolated circuits (e.g., the primary input and the secondary output) has its own return or ground reference. In conventional topologies, the transformer is typically needed for high voltage conversion ranges from the primary input to the secondary output for good efficiency. Use of transformers, however, can cause large winding losses due to a large number of primary turns and high alternating current (AC) content in the secondary windings, which drives winding cost and the cost of the printed circuit boards housing the transformer.

Large datacenters contain rows and rows of server racks, which consume substantial amounts of power at a high cost. The increased power consumption in datacenters is driving a transition from a regulated power infrastructure which provides a voltage in the range of 12 volts of power to server boards to a power infrastructure where the server boards are powered by a voltage in the range of 40-60 volts. The 40-60 volts to 12 volts conversion takes place on the server board. This voltage range has been previously reserved for high-end servers.

### BRIEF DESCRIPTION OF THE DRAWINGS

FIG. 1 is a block diagram representing a schematic configuration of an isolated direct current (DC)-to-DC power converter.

FIG. 2 is a circuit diagram representing a schematic configuration of a non-isolated DC-to-DC power converter according to one embodiment of the present disclosure.

FIG. 3 is a diagram illustrating an example mode of controlling a power converter of FIG. 2 according to one embodiment of the present disclosure.

FIG. 4 is a diagram illustrating an example mode of controlling a power converter of FIG. 2 according to one embodiment of the present disclosure.

FIG. 5 is a graph illustrating a comparison of the efficiency of different modes of controlling a power converter of FIG. 2 according to one embodiment of the present disclosure.

FIG. 6 illustrates a flowchart of a method of converting voltages using the non-isolated DC-to-DC power converter with interconnected transformer windings according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

At least one example embodiment is directed to an apparatus. The apparatus includes a first circuit path including a series combination of a primary winding of a transformer and a first secondary winding of the transformer. The apparatus also includes a second circuit path including a second secondary winding of the transformer. The apparatus also includes multiple switching elements operable to convey energy from a voltage source to the primary winding of the transformer. The switching elements include first switching elements connected on a first side of the transformer. The first switching elements include a first upper switching element, a first middle switching element, and a first lower switching element. The switching elements also include second switching elements connected on a second side of the transformer opposite the first side of the transformer. The second switching elements include a second upper switching element, a second middle switching element, and a second lower switching element. The apparatus also includes control circuitry configured to control switching of the first switching elements and the second switching elements to regulate an output voltage of the apparatus. The control circuitry is operable to operate the first upper switching element and the second upper switching element in a synchronous rectification mode.

At least one example embodiment is directed to a system. The system includes a power converter. The power converter includes a first circuit path including a series combination of a primary winding of a transformer and a first secondary winding of the transformer. The power converter also includes a second circuit path including a second secondary winding of the transformer. The power converter also includes multiple switching elements operable to convey energy from a voltage source to the primary winding of the transformer. The switching elements include first switching elements connected on a first side of the transformer. The first switching elements include a first upper switching element, a first middle switching element, and a first lower switching element. The switching elements also include second switching elements connected on a second side of the transformer opposite the first side of the transformer. The second switching elements include a second upper switching element, a second middle switching element, and a second lower switching element. The power converter also includes control circuitry configured to control switching of the first switching elements and the second switching elements to regulate an output voltage of the apparatus. The control circuitry is operable to operate the first upper switching element and the second upper switching element in a synchronous rectification mode.

At least one example embodiment is directed to a method. The method includes providing a first circuit path including a series combination of a primary winding of a transformer and a first secondary winding of the transformer. The method also includes providing a second circuit path including a second secondary winding of the transformer. The method also includes providing multiple switching elements operable to convey energy from a voltage source to the primary winding of the transformer. The switching elements include first switching elements connected on a first side of the transformer. The first switching elements include a first upper switching element, a first middle switching element, and a first lower switching element. The switching elements also include second switching elements connected on a second side of the transformer opposite the first side of the transformer. The second switching elements comprising a second upper switching element, a second middle switching element, and a second lower switching element. The method also includes providing control circuitry configured to control switching of the first switching elements and the second switching elements to regulate an output voltage of the apparatus. The control circuitry is configured to operate the first upper switching element and the second upper switching element in a synchronous rectification mode.

The subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the subject matter may be practiced without these specific details. In other instances, well-known structures and devices are shown in block diagram form in order to facilitate describing the subject innovation.

Moreover, the word “exemplary” is used herein to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. In addition, the word “coupled” is used herein to mean direct or indirect electrical or mechanical coupling.

The term “converter,” as used herein, encompasses but is not limited to any one of, or any combination of “regulator,” “DC regulator,” “voltage regulator,” “DC voltage regulator,” DC-to-DC converter,” “DC converter” and “converter,” and includes, but is not limited to, the plain meaning of any of these terms.

Some implementations of the present disclosure described herein pertains to an electrically non-isolated DC-to-DC power converter which may be used to deliver power at a low DC voltage from a source having a high DC voltage. In such a power converter, a transformer is used to provide a step-down (or step-up) in voltage level according to its turns-ratio. In other words, the full amount of the transformer current in the primary side is equal to the transformer current in the secondary side. If the system is pulse width modulated, the primary side and the secondary side will average the transformed voltage. In essence, the input power will equal the output power (minus conversion losses). For example, if the input voltage doubles, the input current will be reduced by half, while the output voltage and the output current remain constant. The power circuit switching elements are used in conjunction with capacitors and inductors to create the conversion. In some implementations of the present disclosure, power circuit switching elements are used in conjunction with capacitors and inductors for averaging the pulse width modulated voltage. Control circuitry may be provided to drive signals to the power circuit switching elements.

Most DC-to-DC power converters are designed to provide regulation of their output voltage in the face of input voltage and output current variations. For example, a power converter might need to maintain a 12 volts output (plus or minus a few percent) as its input varies over the range of 36 to 75 volts and its output current ranges from 1 to 25 amps. This ability to provide regulation is usually the result of the power circuit's topology and the manner in which its power circuit switching elements are controlled. Sometimes the regulation function is supplied by (or augmented with) a linear regulator.

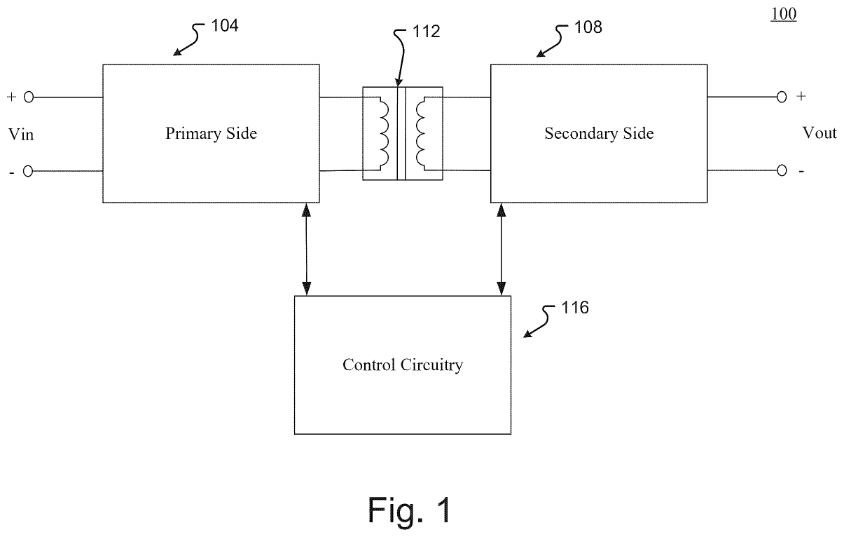

FIG. 1 is a block diagram representing a schematic configuration of an isolated DC-to-DC power converter 100. An isolated power converter isolates the input from the output by electrically and physically separating the circuit for the power converter into two sections preventing direct current flow between the input and output, typically achieved by using a transformer. The power converter 100 generally includes a primary side 104 which includes one or more power circuit switching elements (not shown). The primary side 104 may receive an input voltage from a voltage source Vin. The power converter 100 also includes a secondary side 108 which may include a rectification circuit, a filter circuit and a load (not shown), for example. The secondary side 108 outputs an output voltage Vout. The secondary side 108 is isolated from the primary side by a transformer 112 having one or more primary windings and one or more secondary windings for example. The power converter 100 also includes control circuitry 116 for controlling the power converter 100 by determining when the one or more power circuit switching elements will be turned ON and OFF. Control circuitry 116 typically senses voltages and currents at the input, at the output, and/or within the power converter 100. With this topology of the conventional isolated DC-to-DC power converter 100, the current flowing in the primary side 104 is only circulating in the primary side 104 and the current flowing in the secondary side 108 is only circulating in the secondary side 108 due to the fact that each of the primary side 104 and the secondary side 108 has its own return or ground reference.

In conventional topologies, the transformer is typically needed for high voltage conversion ranges from the input to the output for good efficiency. Use of transformers, however, can cause large winding losses due to a large number of primary turns and high AC content in the secondary windings, which drives winding and printed circuit board costs.

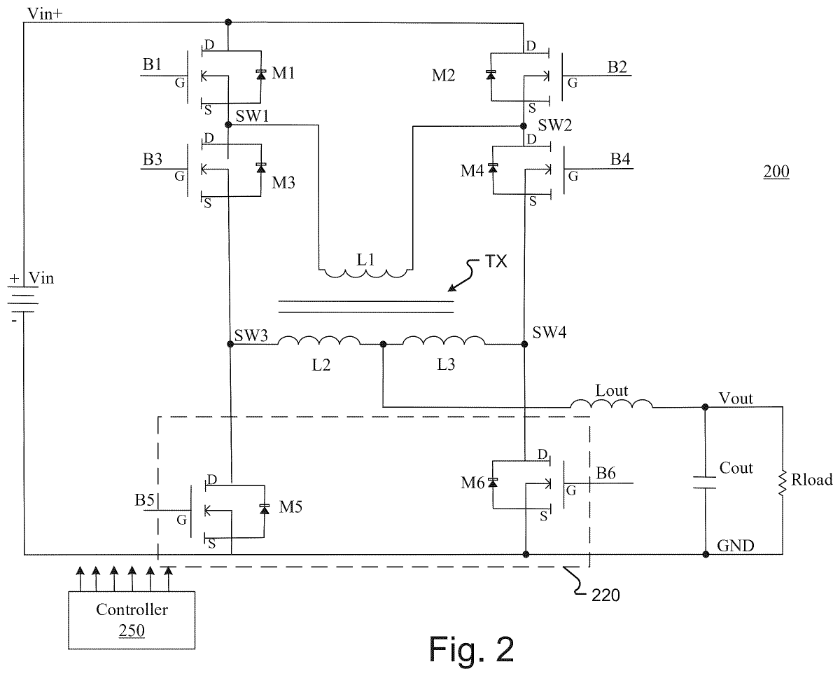

FIG. 2 is a circuit diagram representing a schematic configuration of a non-isolated DC-to-DC power converter 200 according to one embodiment of the present disclosure. The power converter 200 includes a power circuit including power circuit switching elements. The power circuit switching elements include two series connected power circuit switching elements (M1 and M3) in parallel with two series connected power circuit switching elements (M2 and M4) arranged in a full bridge configuration. The power circuit switching elements (M1-M4) may include, for example, metal-oxide-semiconductor field-effect transistor (MOSFET) s or gallium nitride (GaN) FETs. The power circuit also includes an input voltage source (Vin) providing a DC input voltage Vin+ to the power circuit switching elements (M1-M4). The power circuit 204 may be configured to produce a unipolar square-wave voltage.

The power converter 200 also includes an output voltage (Vout) for providing a converted DC voltage as an output voltage, a transformer (TX), a rectification circuit 220, and a load (Rload) 228.

The transformer TX includes a primary winding coupled to the power circuit switching elements M1-M4 and secondary windings coupled to the rectification circuit 220 and an output inductor Lout. The number of windings associated with each of the primary winding and the secondary windings can be of any suitable value and vary depending on the embodiment. The power converter 200 may also include a capacitor Cout. The load (Rload) 228 is symbolized by a resister R. The capacitor Cout is provided to smooth the rectified voltage to the load.

As illustrated in FIG. 2, the rectification circuit 220 includes two power circuit switching elements including a parallel diode (M5 and M6) arranged to provide synchronous rectification. Alternatively, the rectification circuit 220 can include more or less switching devices if desired and/or be configured without synchronous rectification.

Further in this example embodiment, the drain node (D) of the power circuit switching element M1 and the drain node (D) of the power circuit switching element M2 are connected to the input voltage source Vin. Further, the source node(S) of the power circuit switching element M1 is coupled to the drain node (D) of the power circuit switching element M3 (switch node SW1). The source node(S) of the power circuit switching element M2 is coupled to the drain node (D) of the power circuit switching element M4 (switch node SW2). The source node(S) of the power circuit switching element M2 is coupled to switch node SW2. The source node(S) of the power circuit switching element M4 is coupled to switch node SW4. The drain (D) of the power circuit switching element M5 is connected to switch node SW3; the source(S) of the power circuit switching element M5 is connected to ground. The drain (D) of the power circuit switching element M6 is connected to node SW4; the source(S) of the power circuit switching element M6 is connected to ground.

The power converter 200 of FIG. 2 includes one or more controller(s) 250 for generating control signals (e.g., pulse-width modulated (PWM) signals) for the power circuit switching elements M1, M2, M3, M4, M5, and M6. As illustrated in FIG. 2, the control signal B1 controls the power circuit switching element M1; the control signal B2 controls the power circuit switching element M2; the control signal B3 controls the power circuit switching element M3; the control signal B4 controls the power circuit switching element M4; the control signal B5 controls the power circuit switching element M5; and the control signal B6 controls the power circuit switching element M6. The controller 250 of FIG. 2 can include one or more gate drive circuits and/or other suitable drive circuits to generate control signals.

In some implementations, the controller 250 may be adapted to vary a duty cycle of the control signals (e.g., B1, B2, B3, B4, B5, and B6) to regulate the output voltage (Vout). In general, the frequency may normally be kept constant, but the frequency can be modulated to reduce current ripple.

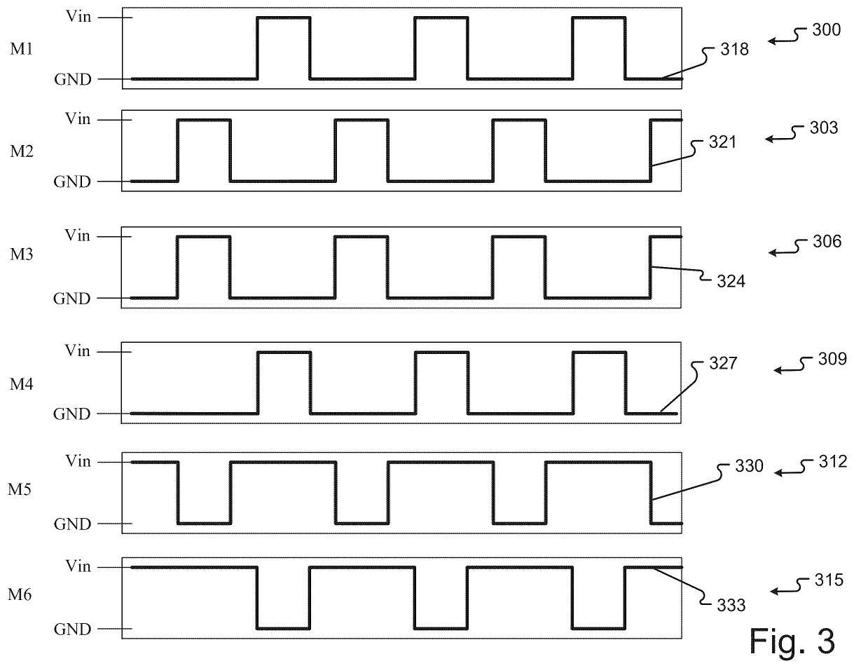

FIG. 3 is a set of graphs 300, 303, 306, 309, 312, 315 illustrating control signals B1, B2, B3, B4, B5, and B6 for power circuit switching elements M1, M2, M3, M4, M5, and M6 for a non-isolated DC-to-DC power converter with interconnected transformer windings according to at least one embodiment of the present disclosure. For each of the graphs 300, 303, 306, 309, 312, 315, the horizontal axis denotes time (e.g., in microseconds (μs)) and the vertical axis denotes the voltage (V) between ground (GND) and input voltage (Vin). The waveform 318 illustrated in graph 300 represents the control signal B1 for the power circuit switching element M1, the waveform 321 illustrated in graph 303 represents the control signal B2 for the power circuit switching element M2, the waveform 324 illustrated in graph 306 represents the control signal B3 for the power circuit switching element M3, the waveform 327 illustrated in graph 309 represents the control signal B4 for the power circuit switching element M4, the waveform 330 illustrated in graph 312 represents the control signal B5 for the power circuit switching element M5, the waveform 333 illustrated in graph 315 represents the control signal B6 for the power circuit switching element M6.

As illustrated in FIG. 3, the waveform 318 illustrated in graph 300 representing the control signal B1 for the power circuit switching element M1 may be a square wave control signal which follows a repeating pattern. The time intervals for the waveform 318 may be defined by a first period (T_off) which may be a time interval during which the control signal B1 is “off” and set to a low voltage (e.g., ground (GND)). During the first period, the switching element M1 may not be conducting. The time intervals for the waveform 318 may be further defined by a second period (T_on) which may be a time interval during which the control signal B1 is “on” and set to a high voltage (e.g., Vin). During the second period, the switching element M1 may be conducting.

The duty cycle of a control signal as described herein may be defined as a ratio of an “on” time (T_on) to a total period (T) of a square wave. By adjusting the duty cycle of the control signals B1-B6 for the power circuit switching elements M1-M6, the average power delivered to a load can be controlled. A higher duty cycle means longer “on” periods, and vice versa. The duration of T_off and T_on can be varied to control the operation of the power circuit effectively.

The waveform 321 illustrated in graph 303 representing the control signal B2 for the power circuit switching element M2 may be a square wave control signal which follows a repeating pattern similar to that of the control signal B1 for the power circuit switching element M1 as described above, but phase-shifted by half of the total period (T). As described above, the first control signal B1 is a square wave following a consistent pattern, where the control signal B1 transitions between the “off” state and the “on” state at regular intervals. In contrast, the control signal B2 may follow the same pattern as the control signal B1 but offset by 50%. This means that the control signal B2 is phase-shifted relative to the control signal B1 by half of the total period (T).

The waveform 324 illustrated in graph 306 representing the control signal B3 for the power circuit switching element M3 is the same as or similar to the control signal B2 for the power circuit switching element M2. Like the control signal B2 for the power circuit switching element M2, the control signal B3 for power circuit switching element M3 may follow the same pattern as the control signal B1 but offset by 50%.

The waveform 327 illustrated in graph 309 representing the control signal B4 for the power circuit switching element M4 is the same as or similar to the control signal B1 for the power circuit switching element M1. Like the control signal B1 for the power circuit switching element M1, the control signal B4 for power circuit switching element M4 may be a square wave control signal which follows a repeating pattern. The time intervals for the waveform 327 may be defined by a first period (T_off) which may be a time interval during which the control signal B4 is “off” and set to a low voltage (e.g., ground (GND)). During the first period, the switching element M4 may not be conducting. The time intervals for the waveform 327 may be further defined by a second period (T_on) which may be a time interval during which the control signal B41 is “on” and set to a high voltage (e.g., Vin). During the second period, the switching element M4 may be conducting.

The waveform 330 illustrated in graph 312 representing the control signal B5 for the power circuit switching element M5 is the inverse of the control signal B2 for the power circuit switching element M2 and the control signal B3 for power circuit switching element M3 as described above. As described above, the control signal B3 follows a consistent pattern, where it transitions between an “off” state and an “on” state at particular intervals. In contrast, the control signal B5 for the power circuit switching element M5 follows the same pattern as the control signal B3 but is inversed. This means that the control signal B5 is the exact opposite of the control signal B3 at any given point in time. When the control signal B3 is in its “on” state, the control signal B5 is in its “off” state, and when the control signal B3 is in its “off” state, the control signal B5 is in its “on” state. This inversion creates a complementary relationship between the two signals, ensuring that one is always high while the other is low, and vice versa.

The waveform 333 illustrated in graph 315 representing the control signal B6 for the power circuit switching element M6 is the inverse of the control signal B1 for the power circuit switching element M1 and the control signal B4 for the power circuit switching element M4 as described above. As described above, the control signal B1 follows a consistent pattern, where it transitions between an “off” state and an “on” state at particular intervals. In contrast, the control signal B6 for the power circuit switching element M6 follows the same pattern as the control signal B1 but is inversed. This means that the control signal B6 is the exact opposite of the control signal B1 at any given point in time. When the control signal B1 is in its “on” state, the control signal B6 is in its “off” state, and when the control signal B1 is in its “off” state, the control signal B6 is in its “on” state.

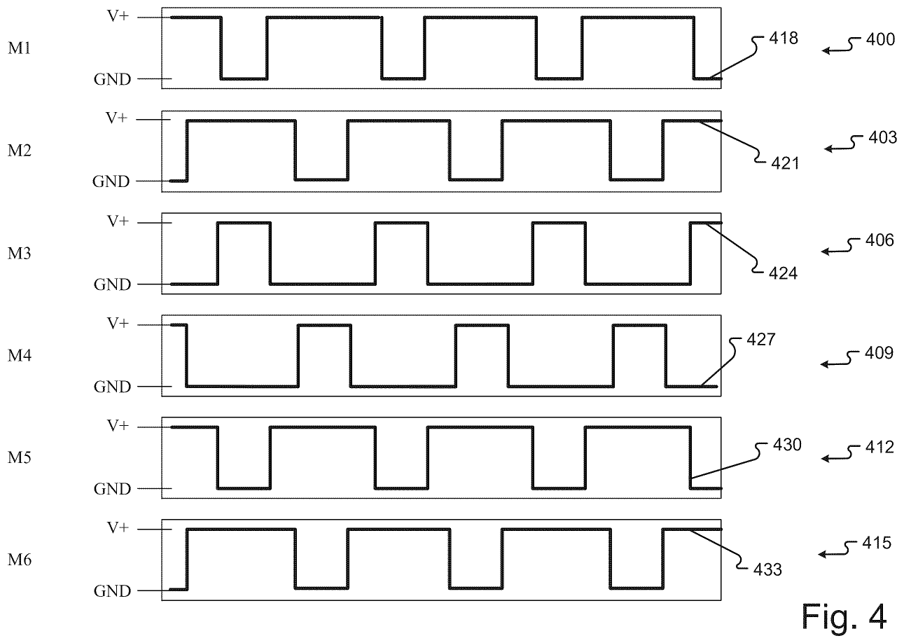

FIG. 4 is a set of graphs 400, 403, 406, 409, 412, 415 illustrating control signals B1, B2, B3, B4, B5, and B6 for power circuit switching elements M1, M2, M3, M4, M5, and M6 for a non-isolated DC-to-DC power converter with interconnected transformer windings according to at least one embodiment of the present disclosure. For each of the graphs 400, 403, 406, 409, 412, 415, the horizontal axis denotes time (e.g., in μs) and the vertical axis denotes the voltage (V) between ground (GND) and input voltage (Vin). The waveform 418 illustrated in graph 400 represents the control signal B1 for the power circuit switching element M1, the waveform 421 illustrated in graph 403 represents the control signal B2 for the power circuit switching element M2, the waveform 424 illustrated in graph 406 represents the control signal B3 for the power circuit switching element M3, the waveform 427 illustrated in graph 409 represents the control signal B4 for the power circuit switching element M4, the waveform 430 illustrated in graph 412 represents the control signal B5 for the power circuit switching element M5, the waveform 433 illustrated in graph 415 represents the control signal B6 for the power circuit switching element M6.

As illustrated in FIG. 4, the waveform 418 illustrated in graph 400 representing the control signal B1 for the power circuit switching element M1 may be a square wave control signal which follows a repeating pattern. The time intervals for the waveform 418 may be defined by a first period (T_off) which may be a time interval during which the control signal B1 is “off” and set to a low voltage (e.g., ground (GND)). During the first period, the switching element M1 may not be conducting. The time intervals for the waveform 418 may be further defined by a second period (T_on) which may be a time interval during which the control signal B1 is “on” and set to a high voltage (e.g., Vin). During the second period, the switching element M1 may be conducting.

The duty cycle of a control signal as described herein may be defined as a ratio of an “on” time (T_on) to a total period (T) of a square wave. By adjusting the duty cycle of the control signals B1-B6 for the power circuit switching elements M1-M6, the average power delivered to a load can be controlled. A higher duty cycle means longer “on” periods, and vice versa. The duration of T_off and T_on can be varied to control the operation of the power circuit effectively.

As compared to the waveform 318 illustrated in graph 300 of FIG. 3, representing the control signal B1 for the power circuit switching element M1 in accordance with the embodiment illustrated in FIG. 3, the waveform 418 illustrated in graph 400 of FIG. 4, representing the control signal B1 for the power circuit switching element M1 in accordance with the embodiment illustrated in FIG. 4 includes a greater amount of time “on” as compared to “off.”

The waveform 421 illustrated in graph 403 representing the control signal B2 for the power circuit switching element M2 may be a square wave control signal which follows a repeating pattern similar to that of the control signal B1 for the power circuit switching element M1 as described above, but phase-shifted by half of the total period (T). As described above, the first control signal B1 is a square wave following a consistent pattern, where the control signal B1 transitions between the “off” state and the “on” state at regular intervals. In contrast, the control signal B2 may follow the same pattern as the control signal B1 but offset by 50%. This means that the control signal B2 is phase-shifted relative to the control signal B1 by half of the total period (T).

As compared to the waveform 321 illustrated in graph 303 of FIG. 3, representing the control signal B2 for the power circuit switching element M2 in accordance with the embodiment illustrated in FIG. 3, the waveform 421 illustrated in graph 403 of FIG. 4, representing the control signal B2 for the power circuit switching element M2 in accordance with the embodiment illustrated in FIG. 4 includes a greater amount of time “on” as compared to “off.”

The waveform 424 illustrated in graph 406 representing the control signal B3 for the power circuit switching element M3, unlike the embodiment illustrated in FIG. 3, includes a lesser amount of time “on” as compared to “off.” The waveform 424 illustrated in graph 406 representing the control signal B3 for the power circuit switching element M3 of the embodiment illustrated in FIG. 4 is the same as or similar to the control signals B2 and B3 for the power circuit switching elements M2 and M3 of the embodiment illustrated in FIG. 3. Like the control signal B2 for the power circuit switching element M2, the control signal B3 for power circuit switching element M3 may be offset by 50% from the control signal B1.

The waveform 427 illustrated in graph 409 representing the control signal B4 for the power circuit switching element M4, unlike the embodiment illustrated in FIG. 3, includes a lesser amount of time “on” as compared to “off.” The waveform 427 illustrated in graph 409 representing the control signal B4 for the power circuit switching element M4 of the embodiment illustrated in FIG. 4 is the same as or similar to the control signals B1 and B4 for the power circuit switching elements M1 and M4 of the embodiment illustrated in FIG. 3. The control signal B4 for power circuit switching element M4 may be in sync with (offset by 0% from) the control signal B1.

The waveform 430 illustrated in graph 412 representing the control signal B5 for the power circuit switching element M5 is the inverse of the control signal B3 for the power circuit switching element M3 as described above. As described above, the control signal B3 follows a consistent pattern, where it transitions between an “off” state and an “on” state at particular intervals. In contrast, the control signal B5 for the power circuit switching element M5 follows the same pattern as the control signal B3 but is inversed. This means that the control signal B5 is the exact opposite of the control signal B3 at any given point in time. When the control signal B3 is in its “on” state, the control signal B5 is in its “off” state, and when the control signal B3 is in its “off” state, the control signal B5 is in its “on” state. This inversion creates a complementary relationship between the two signals, ensuring that one is always high while the other is low, and vice versa.

The waveform 433 illustrated in graph 415 representing the control signal B6 for the power circuit switching element M6 is the inverse of the control signal B4 for the power circuit switching element M4 as described above. As described above, the control signal B4 follows a consistent pattern, where it transitions between an “off” state and an “on” state at particular intervals. In contrast, the control signal B6 for the power circuit switching element M6 follows the same pattern as the control signal B4 but is inversed. This means that the control signal B6 is the exact opposite of the control signal B4 at any given point in time. When the control signal B4 is in its “on” state, the control signal B6 is in its “off” state, and when the control signal B4 is in its “off” state, the control signal B6 is in its “on” state.

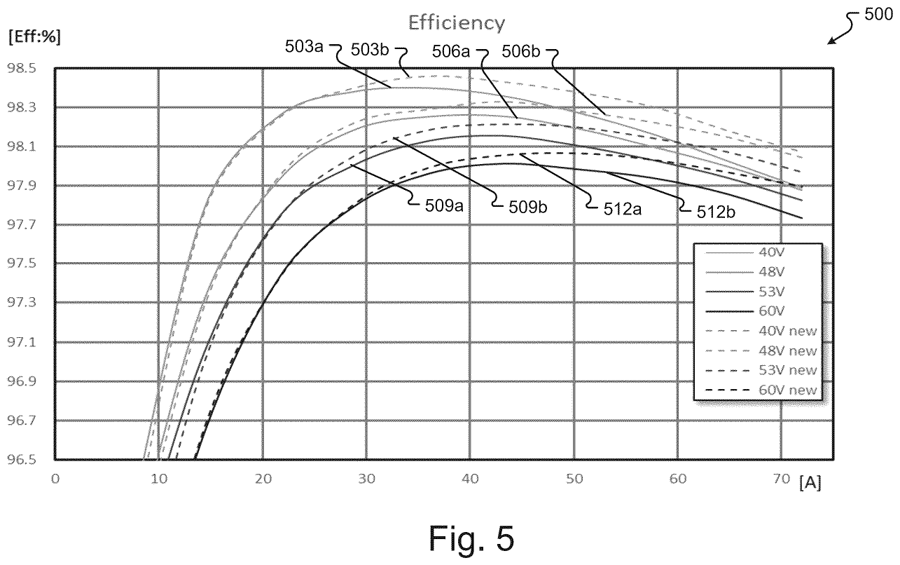

FIG. 5 illustrates efficiency of a DC-to-DC power converter as described herein as compared to a conventional DC-to-DC power converter at various operating voltages. Efficiency, on a scale from 96.5% to 98.5%, is illustrated by the vertical axis. Current (in terms of Amperage), on a scale from 0 to 75 A, is illustrated by the horizontal axis. An efficiency of a conventional DC-to-DC power converter operating at a voltage of 40 V is illustrated by dashed line 503a. An efficiency of a DC-to-DC power converter as described herein operating at a voltage of 40 V is illustrated by solid line 503b. An efficiency of a conventional DC-to-DC power converter operating at a voltage of 48 V is illustrated by dashed line 506a. An efficiency of a DC-to-DC power converter as described herein operating at a voltage of 48 V is illustrated by solid line 506b. An efficiency of a conventional DC-to-DC power converter operating at a voltage of 53 V is illustrated by dashed line 509a. An efficiency of a DC-to-DC power converter as described herein operating at a voltage of 53 V is illustrated by solid line 509b. An efficiency of a conventional DC-to-DC power converter operating at a voltage of 60 V is illustrated by dashed line 512a. An efficiency of a DC-to-DC power converter as described herein operating at a voltage of 60 V is illustrated by solid line 512b.

As may be appreciated by the table 500 of FIG. 5, the efficiency achieved by DC-to-DC power converters as described herein may be at an increased level as compared to conventional DC-to-DC converters, particularly when operating at higher power levels (i.e., at higher currents).

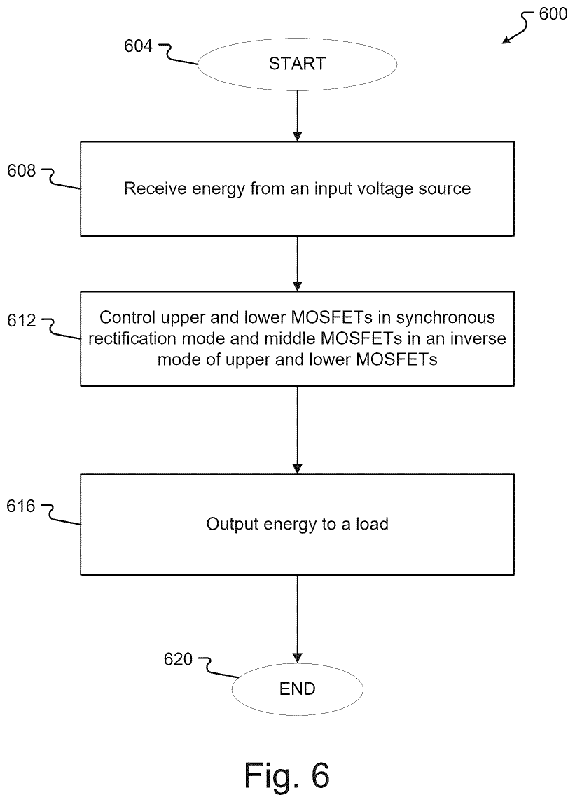

FIG. 6 illustrates a flowchart of a method 600 of converting voltages using the non-isolated DC-to-DC power converter with interconnected transformer windings according to one embodiment of the present disclosure.

While a general order for the steps of the method 600 for converting voltages using the non-isolated DC-to-DC power converter with interconnected transformer windings is shown in FIG. 6, the method 600 can include more or fewer steps or can arrange the order of the steps differently than those shown in FIG. 6. Further, two or more steps may be combined into one step. Generally, the method 600 starts with a START operation 604 and ends with an END operation 620. The method can be executed on a set of computer-executable instructions executed by a data processing system and encoded or stored on a computer readable medium. Herein, the method 600 shall be explained with reference to systems and components described above.

Method 600 may start at START operation 604 and proceed to step 608 where the energy is received from an input voltage source. After energy is received from the input voltage source at step 608, method 600 proceeds to step 612, where a controller 250 as described herein may control upper MOSFETs (M1 and M2) and lower MOSFETs (M5 and M6) in a synchronous rectification mode and middle MOSFETs (M3 and M4) in an inverse mode of the upper MOSFETs (M1 and M2) and the lower MOSFETs (M5 and M6). After the controller 250 controls the upper MOSFETs (M1 and M2) and the lower MOSFETs (M5 and M6) in the synchronous rectification mode and the middle MOSFETs (M3 and M4) in the inverse mode of the upper MOSFETs (M1 and M2) and the lower MOSFETs (M5 and M6) at step 612, method 600 proceeds to step 616 where energy converted from an input voltage (Vin) to an output voltage (Vout) is output to a load. After the energy is output to the load, the method 600 proceeds to END operation 620 where method 600 may end.

Any of the steps, functions, and operations discussed herein can be performed continuously and automatically.

The exemplary devices, systems and methods of this disclosure have been described in relation to a power converter. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include an apparatus. The apparatus includes a first circuit path including a series combination of a primary winding of a transformer and a first secondary winding of the transformer. The apparatus also includes a second circuit path including a second secondary winding of the transformer. The apparatus also includes multiple switching elements operable to convey energy from a voltage source to the primary winding of the transformer. The switching elements include first switching elements connected on a first side of the transformer. The first switching elements include a first upper switching element, a first middle switching element, and a first lower switching element. The switching elements also include second switching elements connected on a second side of the transformer opposite the first side of the transformer. The second switching elements includes a second upper switching element, a second middle switching element, and a second lower switching element. The apparatus also includes control circuitry configured to control switching of the first switching elements and the second switching elements to regulate an output voltage of the apparatus. The control circuitry operates the first upper switching element and the second upper switching element in a synchronous rectification mode.

Aspects of the above apparatus include wherein the control circuitry operates the first middle switching element in synchronization with the first upper switching element and the second middle switching element in synchronization with the second upper switching element.

Aspects of the above apparatus include wherein the control circuitry operates the first lower switching element in an inverse synchronization with the first upper switching element and the second lower switching element in an inverse synchronization with the second upper switching element.

Aspects of the above apparatus include wherein the first and second secondary windings of the transformer are operative to generate the output voltage of the apparatus based on the energy conveyed to the primary winding of the transformer.

Aspects of the above apparatus include wherein the output voltage is a direct current (DC) voltage.

Aspects of the above apparatus include wherein the energy conveyed to the primary winding of the transformer is DC energy.

Aspects of the above apparatus include the apparatus further including an inductor connected between the first and second secondary windings of the transformer.

Embodiments include a system. The system includes a power converter. The power converter includes a first circuit path including a series combination of a primary winding of a transformer and a first secondary winding of the transformer. The power converter also includes a second circuit path including a second secondary winding of the transformer. The power converter also includes multiple switching elements operable to convey energy from a voltage source to the primary winding of the transformer. The switching elements include first switching elements connected on a first side of the transformer. The first switching elements include a first upper switching element, a first middle switching element, and a first lower switching element. The switching elements also include second switching elements connected on a second side of the transformer opposite the first side of the transformer. The second switching elements includes a second upper switching element, a second middle switching element, and a second lower switching element. The power converter also includes control circuitry configured to control switching of the first switching elements and the second switching elements to regulate an output voltage of the power converter. The control circuitry operates the first upper switching element and the second upper switching element in a synchronous rectification mode.

Aspects of the above system include wherein the control circuitry operates the first middle switching element in synchronization with the first upper switching element and the second middle switching element in synchronization with the second upper switching element.

Aspects of the above system include wherein the control circuitry operates the first lower switching element in an inverse synchronization with the first upper switching element and the second lower switching element in an inverse synchronization with the second upper switching element.

Aspects of the above system include wherein the first and second secondary windings of the transformer are operative to generate the output voltage of the power converter based on the energy conveyed to the primary winding of the transformer.

Aspects of the above system include wherein the output voltage is a direct current (DC) voltage.

Aspects of the above system include wherein the energy conveyed to the primary winding of the transformer is DC energy.

Aspects of the above system include the power converter further including an inductor connected between the first and second secondary windings of the transformer.

Embodiments include a method. The method includes providing a first circuit path including a series combination of a primary winding of a transformer and a first secondary winding of the transformer. The method also includes providing a second circuit path including a second secondary winding of the transformer. The method also includes providing multiple switching elements operable to convey energy from a voltage source to the primary winding of the transformer. The switching elements include first switching elements connected on a first side of the transformer. The first switching elements include a first upper switching element, a first middle switching element, and a first lower switching element. The switching elements also include second switching elements connected on a second side of the transformer opposite the first side of the transformer. The second switching elements include a second upper switching element, a second middle switching element, and a second lower switching element. The method also includes providing control circuitry configured to control switching of the first switching elements and the second switching elements to regulate an output voltage of the power converter. The control circuitry operates the first upper switching element and the second upper switching element in a synchronous rectification mode.

Aspects of the above method include wherein the control circuitry operates the first middle switching element in synchronization with the first upper switching element and the second middle switching element in synchronization with the second upper switching element.

Aspects of the above method include wherein the control circuitry operates the first lower switching element in an inverse synchronization with the first upper switching element and the second lower switching element in an inverse synchronization with the second upper switching element.

Aspects of the above method include wherein the first and second secondary windings of the transformer are operative to generate the output voltage of the power converter based on the energy conveyed to the primary winding of the transformer.

Aspects of the above method include wherein the output voltage is a direct current (DC) voltage.

Aspects of the above method include wherein the energy conveyed to the primary winding of the transformer is DC energy.

Aspects of the above method include further providing an inductor connected between the first and second secondary windings of the transformer.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, power converter, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, power converter, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably, and include any type of methodology, process, mathematical operation, or technique.

The present disclosure, in various aspects, embodiments, and/or configurations, includes components, methods, processes, systems, power converters, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving case and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An apparatus, comprising:
a first circuit path including a series combination of a primary winding of a transformer and a first secondary winding of the transformer;
a second circuit path including a second secondary winding of the transformer;
multiple switching elements operable to convey energy from a voltage source to the primary winding of the transformer, the switching elements comprising:
first switching elements connected on a first side of the transformer, the first switching elements comprising a first upper switching element, a first middle switching element, and a first lower switching element; and
second switching elements connected on a second side of the transformer opposite the first side of the transformer, the second switching elements comprising a second upper switching element, a second middle switching element, and a second lower switching element; and
control circuitry configured to control switching of the first switching elements and the second switching elements to regulate an output voltage of the apparatus, wherein the control circuitry operates the first upper switching element and the second upper switching element in a synchronous rectification mode.

2. The apparatus of claim 1, wherein the control circuitry operates the first middle switching element in synchronization with the first upper switching element and the second middle switching element in synchronization with the second upper switching element.

3. The apparatus of claim 1, wherein the control circuitry operates the first lower switching element in an inverse synchronization with the first upper switching element and the second lower switching element in an inverse synchronization with the second upper switching element.

4. The apparatus of claim 1, wherein the first and second secondary windings of the transformer are operative to generate the output voltage of the apparatus based on the energy conveyed to the primary winding of the transformer.

5. The apparatus of claim 4, wherein the output voltage is a direct current (DC) voltage.

6. The apparatus of claim 4, wherein the energy conveyed to the primary winding of the transformer is DC energy.

7. The apparatus of claim 1, further comprising an inductor connected between the first and second secondary windings of the transformer.

8. A system, comprising:
a power converter comprising:
a first circuit path including a series combination of a primary winding of a transformer and a first secondary winding of the transformer;
a second circuit path including a second secondary winding of the transformer;
multiple switching elements operable to convey energy from a voltage source to the primary winding of the transformer, the switching elements comprising:
first switching elements connected on a first side of the transformer, the first switching elements comprising a first upper switching element, a first middle switching element, and a first lower switching element; and
second switching elements connected on a second side of the transformer opposite the first side of the transformer, the second switching elements comprising a second upper switching element, a second middle switching element, and a second lower switching element; and
control circuitry configured to control switching of the first switching elements and the second switching elements to regulate an output voltage of the power converter, wherein the control circuitry operates the first upper switching element and the second upper switching element in a synchronous rectification mode.

9. The system of claim 8, wherein the control circuitry operates the first middle switching element in synchronization with the first upper switching element and the second middle switching element in synchronization with the second upper switching element.

10. The system of claim 8, wherein the control circuitry operates the first lower switching element in an inverse synchronization with the first upper switching element and the second lower switching element in an inverse synchronization with the second upper switching element.

11. The system of claim 8, wherein the first and second secondary windings of the transformer are operative to generate the output voltage of the power converter based on the energy conveyed to the primary winding of the transformer.

12. The system of claim 11, wherein the output voltage is a direct current (DC) voltage.

13. The system of claim 11, wherein the energy conveyed to the primary winding of the transformer is DC energy.

14. The system of claim 8, further comprising an inductor connected between the first and second secondary windings of the transformer.

15. A method, comprising:
providing a first circuit path including a series combination of a primary winding of a transformer and a first secondary winding of the transformer;
providing a second circuit path including a second secondary winding of the transformer;
providing multiple switching elements operable to convey energy from a voltage source to the primary winding of the transformer, the switching elements comprising:
first switching elements connected on a first side of the transformer, the first switching elements comprising a first upper switching element, a first middle switching element, and a first lower switching element; and
second switching elements connected on a second side of the transformer opposite the first side of the transformer, the second switching elements comprising a second upper switching element, a second middle switching element, and a second lower switching element; and
providing control circuitry configured to control switching of the first switching elements and the second switching elements to regulate an output voltage of the power converter, wherein the control circuitry operates the first upper switching element and the second upper switching element in a synchronous rectification mode.

16. The method of claim 15, wherein the control circuitry operates the first middle switching element in synchronization with the first upper switching element and the second middle switching element in synchronization with the second upper switching element.

17. The method of claim 15, wherein the control circuitry operates the first lower switching element in an inverse synchronization with the first upper switching element and the second lower switching element in an inverse synchronization with the second upper switching element.

18. The method of claim 15, wherein the first and second secondary windings of the transformer are operative to generate the output voltage of the power converter based on the energy conveyed to the primary winding of the transformer.

19. The method of claim 18, wherein the output voltage is a direct current (DC) voltage.

20. The method of claim 15, wherein the energy conveyed to the primary winding of the transformer is DC energy.
